(19) United States
(12) Patent Application Publication
(10) Pub. No.: US 2008/0114692 A1
(43) Pub. Date: May 15, 2008

(54) System for allowing content protected by a first DRM system to be accessed by a second DRM system

(76) Inventors: Fabrice Jogand-Coulomb, San Carlos, CA (US); Haluk K. Tanik, Batman (TR); Oktay S. Rasizade, Castro Valley, CA (US)

Correspondence Address: BRINKS HOFER GILSON & LIONE/SanDisk, P.O. BOX 10395, CHICAGO, IL, 60610, US

(21) Appl. No.: 11/599,991

(22) Filed: Nov. 14, 2006

(51) Int. Cl. G06Q 99/00

(52) U.S. Cl. 705/59

(57) ABSTRACT

A system and computer-readable media storing operational instructions for allowing content protected by a first DRM system to be accessed by a second DRM system are disclosed. In one embodiment, a request is received from a host application for a license for content protected by a first DRM system, the first DRM system being different from the host application's DRM system. A license supported by the host application's DRM system is then generated from a license supported by the first DRM system. In another embodiment, a request is received to store content protected by a first DRM system. In response to the request, a portable license for the content is generated from a license supported by the first DRM system. Alternatively or additionally, a portable file format for the content is generated from a file format supported by the first DRM system. The request can come from a first computing platform, and the portable license and/or file format can be generated by a second computing platform. Other embodiments are disclosed, and each of the embodiments can be used alone or together in combination.

### BACKGROUND

A digital rights management (“DRM”) system is used to provide or limit access to content according to a set of permissions, which are usually stored in a license. Differences in DRM systems (e.g., differences in file format and/or license format) can prevent an application operating with one type of DRM system from accessing content protected by a different type of DRM system. Consider, for example, an application that uses a DRM system that specifies a file format with a header that contains information needed to allow the application to access the content. If this application attempts to access content protected by a different DRM system that does not specify a header in its file format, the application will not find the needed information and will not be able to access the content.

### SUMMARY

The present invention is defined by the claims, and nothing in this section should be taken as a limitation on those claims.

By way of introduction, the embodiments described below provide a system and computer-readable media storing operational instructions for allowing content protected by a first DRM system to be accessed by a second DRM system. In one embodiment, a request is received from a host application for a license for content protected by a first DRM system, the first DRM system being different from the host application's DRM system. A license supported by the host application's DRM system is then generated from a license supported by the first DRM system. In another embodiment, a request is received to store content protected by a first DRM system. In response to the request, a portable license for the content is generated from a license supported by the first DRM system. Alternatively or additionally, a portable file format for the content is generated from a file format supported by the first DRM system. The request can come from a first computing platform, and the portable license and/or file format can be generated by a second computing platform. Other embodiments are disclosed, and each of the embodiments can be used alone or together in combination.

The embodiments will now be described with reference to the attached drawings.

### BRIEF DESCRIPTION OF THE DRAWINGS

FIG. 1 is an illustration of a host device and a portable memory device of an embodiment.

FIG. 2 is an illustration of a software agent of an embodiment.

FIG. 3 is a flow chart of a method of an embodiment for converting a file format and a license format.

FIG. 4 is an illustration of an embodiment showing conversion of a file format.

FIG. 5 is an illustration of another host device communicating with the portable memory device of FIG. 1.

FIG. 6 is an illustration of a software agent of the host device of FIG. 5.

FIG. 7 is a flow chart of a method of an embodiment for allowing content protected by a first DRM system to be accessed by a second DRM system.

FIG. 8 is a flow chart showing the acts in the “check license” act in FIG. 7.

### DETAILED DESCRIPTION OF THE PRESENTLY PREFERRED EMBODIMENTS

The embodiments described below generally relate to allowing content that is protected by one type of digital rights management (“DRM”) system to be used by an application that uses a different type of DRM system. As used herein, “content” refers to digital media and can include, but is not limited to, an audio file, a video file (with or without audio), a game, a book, a map, a data file, or a software program. A DRM system controls access to content. As used herein, “access” is any action taken with respect to the content. Examples of various types of “access” include, but are not limited to, playing, displaying, printing, copying, and executing. A DRM system is used to provide or limit access to content according to a set of permissions, which are usually stored in a license associated with the content. (As used herein, a “permission” is used to refer to either a permission or a restriction.) A license (which may also be referred to herein as a “license object” or a “content license”) is an entity that stores permissions regarding the access of content. For example, the license can restrict the number of times the content can be accessed or set an expiration date and time for such access. A license can also contain information about how to un-cipher ciphered content (e.g., a cipher key). A license can be stored in any suitable location, with or separate from its associated content. For example, in one embodiment, both the license and the content are stored together on a portable memory device, while, in another embodiment, the content is stored in the host or the network (or on a portable memory device), and the license is storied in a portable memory device (or in the network). Accordingly, the content and the license do not need to be stored on the same device.

Differences in DRM systems can prevent an application operating with one type of DRM system from accessing content protected by a different type of DRM system. An application operating under a certain type of DRM system may expect to find certain information at certain locations (in the content or in the license, for example), and if the application does not find that information at that location, the application may not be able to access the content. One difference between DRM systems can be file format. Content is usually stored in a file characterized by a file format (e.g., whether or not the file has a header or footer, the location in the file where the content starts/stops, etc.). Differences in file format can lead to incompatibility. For example, the file format for the iMode DRM system is a regular file format. However, the file format for the OMA DRM system contains a header that contains information needed for the OMA DRM system to access the content (e.g., identification and location of the license that contains the cipher key and permissions). Accordingly, when an application operating with the OMA DRM system attempts to read a file protected by the i-Mode DRM system, the application will not find the expected header (since one is not present in an i-Mode-protected file), and the application will not be able to access the content. (Although OMA and i-Mode were used in this example, it should be understood that these embodiments can be used with any suitable type of DRM system.) Another difference between DRM systems can be license format. As with file format, if an application operating under a certain type of DRM system does not find certain information at a certain location in the license, the application may not be able to check the license for permission and, accordingly, may not be able to access the content associated with the license. Different DRM systems may also have different license acquisition protocols.

The embodiments described herein provide a component that performs the required translations/conversions to allow content protected by one type of DRM system to be compatible with an application using a different type of DRM system. In the following example, the component takes the form of a software agent running on a host device. As will be explained more below, the component can be take other forms and be located at different locations (e.g., in a second computing platform in a portable memory device). The component can also be distributed among different components (e.g., between a host device and a portable memory device).

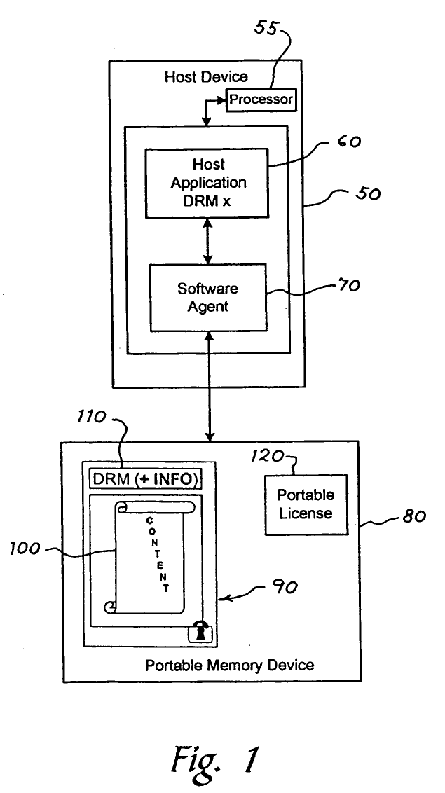

Turning now to the drawings, FIG. 1 shows a host device 50 and a portable memory device 80. As used herein, a “host device” is any device that can be used to access content and includes, but is not limited to, a cell phone, a PC/notebook computer, a handheld computer, a handheld game console, an audio player (e.g., an MP3 player), a video player (e.g., a DVD player or a portable video player), an audio and/or video recorder, a digital camera, a set-top box, a display device (e.g., a television), a printer, a car stereo, and a navigation system. The host device 50 in FIG. 1 comprises one or more processors 55 executing a host application 60 and a software agent 70. As will be described below, the software agent 70 provides “cross DRM” compatibility and can provide other functions, such as security management functionality (e.g., login and decrypting mechanisms). The host application 60 and the software agent 70 can be implemented as computer-readable instructions stored on a computer-readable medium and executed by one or more processors 55 on the host device 50. Although the host application 60 and the software agent 70 are shown as separate components, in an alternate embodiment, those components can be combined into a single component. Other components of the host device 50, such as a display device and driver(s), are not shown in FIG. 1 for simplicity.

As used herein, a “host application” refers to any application that can be used to access content. Examples of a host application include, but are not limited to, an audio player, a video player, and a document viewer. In addition to accessing content, a host application can have other functions, such as downloading content and storing information on a portable memory device. In this example, the host application 60 is operating under a DRM system referred to herein as “DRM x.”

The host device 50 is in communication with the portable memory device 80. In general, a portable memory device is any device that contains a storage medium that can store content and be put in communication with a host device that can access the content stored in the storage medium. A portable memory device can contain only memory (and associated circuitry) or can also contain other components, such as a processor. Examples of portable memory devices include, but are not limited to, a removable memory card (e.g., a non-volatile, solid-state memory device, such as a flash memory card), an optical disc, a magnetic disk, as well as any of the examples of host devices listed above, when those devices have a storage medium and the capability of being placed in (wired or wireless) communication with a host device to access information stored in the storage medium. Accordingly, a “host device” in some situations can be a “portable memory device” to another host device in other situations. For example, in some situations, a cell phone can be used as a host device. However, in other situations, a cell phone can be used as a portable memory device when the cell phone is connected to a personal computer so content can be delivered from the cell phone to the personal computer. As can be seen from these examples, a portable memory device can serve as a dedicated storage device or can contain additional functionality, such as playing music, making phone calls, etc. It should be noted that content and/or a license can be provided to the host device without the use of a portable memory device (such as when the host device downloads the content and/or the license from a server). Accordingly, a host device does not necessarily have to “host” a portable memory device in order to receive the content and/or a license for the content

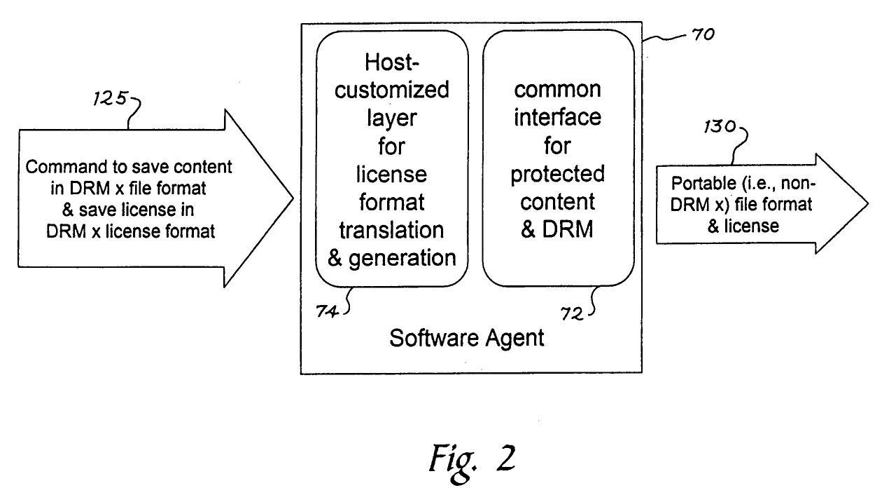

In this embodiment, the software agent 70 acts as a component that allows DRM x protected content to be accessible by different types of DRM systems. FIG. 2 is an illustration showing more detail of the software agent 70. As shown in FIG. 2, the software agent 70 comprises (1) a common interface 72 for protected content and DRM and (2) a host-customized layer 74 for license format translation and generation. (The software agent 70 can have other components, which are not shown in FIG. 2 to simplify the drawing.) The basic principle of compatibility in this embodiment is that the software agent 70 is not only loaded onto the host device 50 in FIG. 1, but is also loaded onto other host devices that wish to gain “cross DRM” compatibility. The common interface 72 is the same in each of these software agents, while the host-customized layer 74 is customized to the DRM system of a particular host device. Provided the DRM protected content has a file format and a license format that the common interface 72 can understand, the host-customized layer can generate a license that is supported by the host application's DRM system and provide access to the content—even if the file format and/or the license format of the DRM protected content is not supported by the host application's DRM system.

Returning now to FIG. 1, when the host application 60 wishes to save protected content to the portable memory device 80, because the host application 60 is operating under DRM x, the host application 60 would issue a command to save the content in a DRM x file format and to save a license in a DRM x license format (as shown by arrow 125 in FIG. 2). (Alternatively, the host application 60 can issue a command to save the content in a cross-DRM format.) However, in this example, DRM x is not supported by the common interface 72. Accordingly, if the content and the license were saved in a DRM x format, software agents in other host devices would not be able to read the content and the license, thereby preventing host applications on other host devices from accessing the protected content.

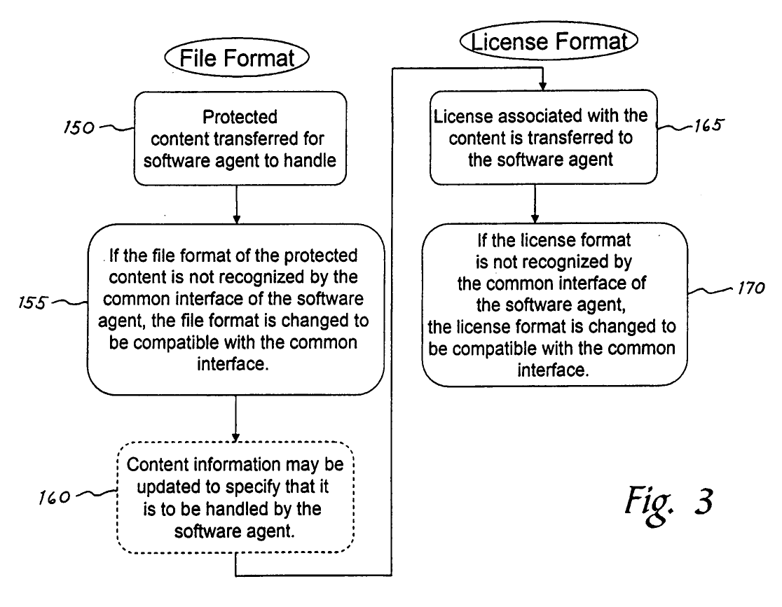

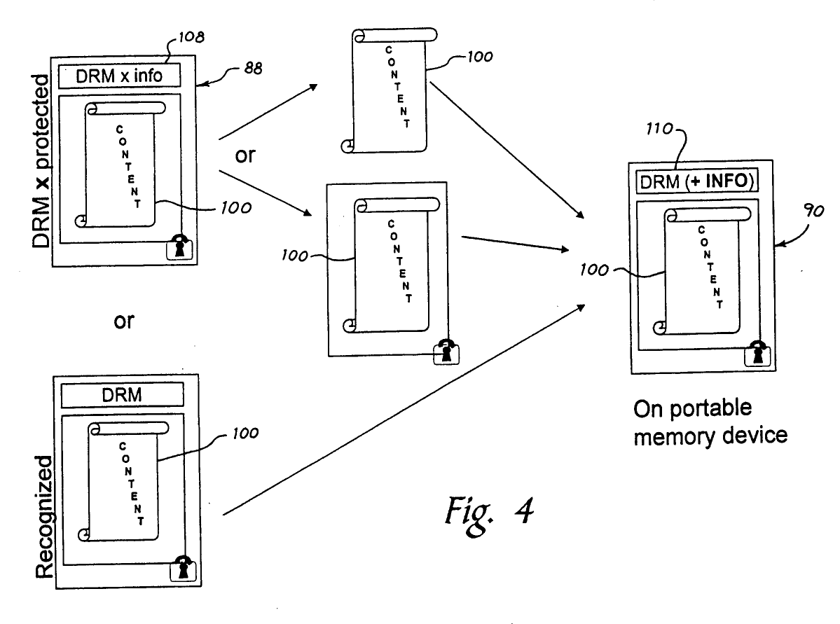

To make the content and license “cross-DRM” compatible, the software agent 70 performs the method shown in the flow chart in FIG. 3. First, the protected content is transferred to the software agent 70 to handle (act 150). Next, if the file format of the protected content is not recognized by the common interface 72 of the software agent 70, the file format is changed to be compatible with the common interface 72 (act 155). This act is illustrated diagrammatically in FIG. 4. In FIG. 4, a file 88 contains the protected content 100 (which is shown as ciphered) and a header 108 that stores information used in the DRM x system. This file format is not recognized by the common interface 72 of the software agent 70. Accordingly, the host-customized layer 72 works with the common interface 72 to change the file format to be compatible with the common interface 72. As shown by the two arrows in FIG. 4, to do this, the content can be un-ciphered and then stored as ciphered on the portable memory device 80, or the ciphered content can simply be moved to the portable memory device 80. In either situation, the result is a file 90 with a file format that is recognized by the common interface 72 of the software agent 70; here, with a header 110 containing the DRM information (e.g., play only five times, etc.).

As shown in optional act 160 in FIG. 3, content information may be updated to specify that the content is to be handled by the software agent. In FIG. 4, this information is shown as “+INFO” in the file header 110. When a software agent on the same or different host device attempts to access the content, it will see this information and know that it needs to perform the cross-DRM functionality described below. As also shown in FIG. 4, even if the file format is recognized, it may be preferred to update the content information to specify that the content is to be handled by the software agent, as the software agent may be able to perform addition functions with respect to this content. Examples of such additional functions are described in the patent documents referenced below.

Returning to the flow chart of FIG. 3, the license associated with the content is transferred to the software agent 70 (act 165). The permissions could be transferred directly instead of the license specific to the DRM system. If the license format is not recognized by the common interface 72 of the software agent 70, the license format is changed to be compatible with the common interface 72 (act 170). In some cases, the permissions are extracted and imported in a compatible object or structure used as the portable license. Accordingly, as shown by arrow 130 in FIG. 2, the software agent 70 generates a portable (i.e., non-DRM x (e.g., DRM z)) file format and license even thought the software agent 70 received a command (arrow 125) to store the content and license in a DRM x format. The portable file 90 and the portable license 120 are then stored in the portable memory device 80, as shown in FIG. 1. (As will be explained below, one or both of the acts of generating the portable file format and portable license can be performed by the host device, by the portable memory device, or by some other device.)

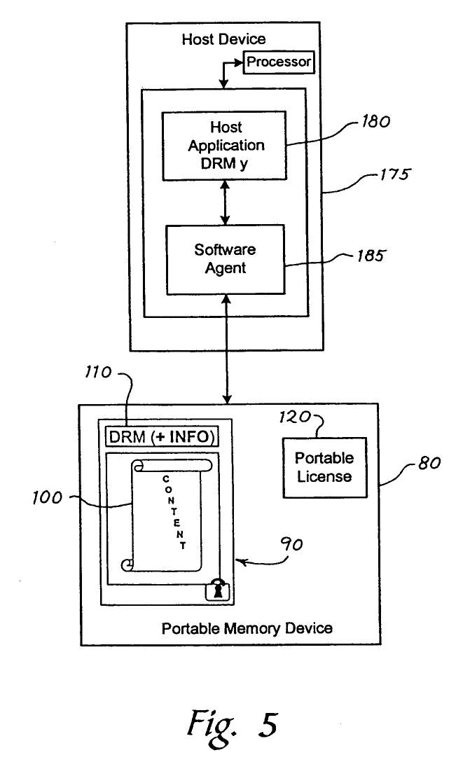

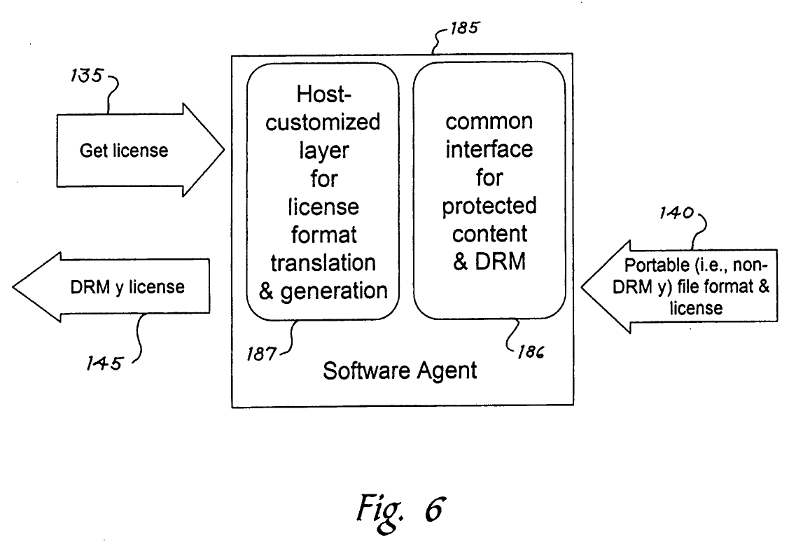

The use of this portable file format and portable license 120 to provide cross-DRM compatibility will now be described. Consider, for example, the situation shown in FIG. 5 in which the portable memory device 80 is then placed in communication with another host device 175. This host device 175 comprises a host application 180 operating with a DRM system (DRM y) that is both different from the DRM system of the host application 60 (DRM x) that stored the content 100 on the portable memory device 80 as well as different from the portable DRM system (DRM z). This host device 175 also comprises a software agent 185, which, as shown in FIG. 6 comprises a common interface 186 and a host-customized layer 187. The common interface 186 of this software agent 185 is the same as the common interface 72 of the other software agent 70. However, the host-customized layer 187 of this software agent 186 is customized for DRM y instead of DRM x.

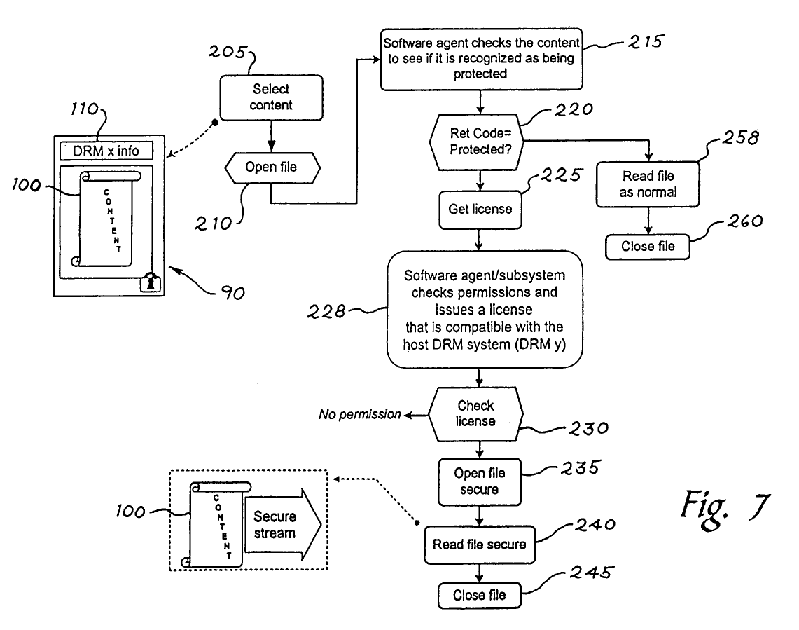

FIG. 7 is a flow chart of a method for allowing content protected by a portable DRM to be accessed by the host application 180 operating with DRM y. The first act in this method is to select content (act 205). Content can be selected in any suitable manner. For example, the host application 180 (or another application) on the host device 175 can present a user with a menu of content options for the user to manually select the content. Many alternatives can be used. For example, instead of using a menu, the user can type-in the name of the content he wants to select, or the content can be automatically selected for the user (as when the host application 180 automatically selects content based on prior selection choices made by the user). As shown in FIG. 7 and discussed previously, the content 100 is protected with a portable DRM that is recognized by common interface modules of all software agents operating in this cross-DRM environment. After the content 100 has been selected, the host application 180 issues an “open file” command to the software agent 185 to open the file 90 (act 210). The software agent 185 then checks the content to see if it is recognized by the software agent 185 as being protected (act 215). In this embodiment, the common interface module 186 reads the header 110 to look for the stored information discussed previously. The software agent 185 then sends the appropriate code back to the host application 180, and the host application 180 determines if the returned code states “protected” (act 220). (The code can, but does not have to, use the actual phrase “protected.” That is, another phrase (or character or, more generally, data) can be used in place of the word “protected.”) If the returned code does not state “protected,” the host application 180 reads the file 90 (i.e., accesses the content 100) as normal (act 258) and then closes the file 90 (act 260).

If the returned code states “protected,” the host application 180 sends a “get license” command (see arrow 135 in FIG. 6) to the software agent 185 (act 225). In response to the “get license” command, the software agent 185 (or a “subsystem,” as will be explained below) acquires the portable license 120 (see arrow 140 in FIG. 6), checks the permissions in the portable license 120, and then generates a license that is compatible with the DRM system of the host application 180 (i.e., DRM y) (see arrow 146 in FIG. 6). In operation, since the portable license 120 was designed to be read by common interface modules of every participating software agent, the common interface module 186 in the software agent 185 is able to read the portable license 120. The host-customized layer 187 knows the format needed for the host application's DRM system (DRM y) and works with the common interface 186 to generate a license supported by DRM y from the portable license 120, even though the portable license 120 is supported by a different DRM system (e.g., DRM z). The generated license is then provided to the host application 180.

It should be noted that the generated license can have the same or different permissions as the permissions in the portable license 120. For example, the generated license can have all or some of the permissions that are in the portable license 120 (e.g., play five times, no ring tones, etc.) as well as additional permissions such as cannot move, cannot copy, or play only once. (The restrictions of “cannot move” and “cannot copy” may be preferred because if the file were moved with the generated license, there may be an incompatibility issue with other host applications.) Accordingly, the permissions in the generated license do not necessarily exactly match the permissions in the portable license. With the license returned, the license is checked to see if there is permission to access the content (act 230). If there is permission, the file 90 is opened in a secure manner (act 235), and the file 90 is read in a secure manner (act 240) (i.e., the content 100 is streamed in a secure manner without DRM specifics). The file is then closed (act 245).

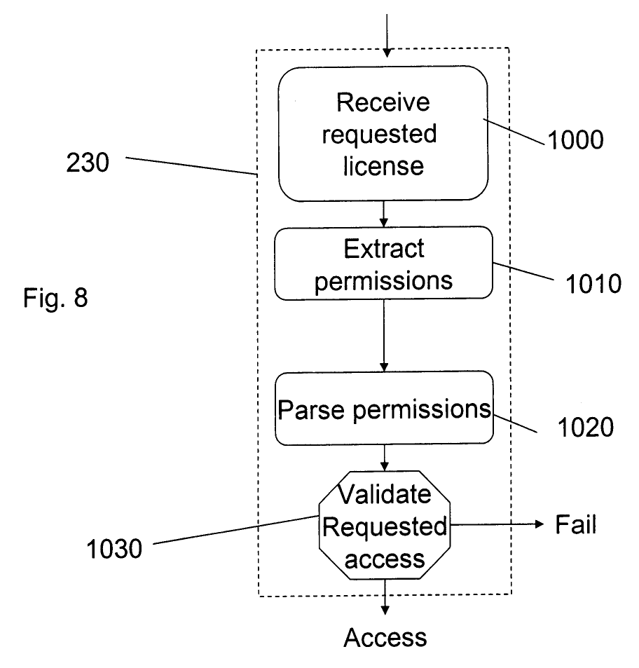

FIG. 8 is a flow chart showing more detail of the check license act (act 230). As shown in FIG. 8, the host application 180 receives the requested license (act 1000). The host application 180 then extracts the permissions (act 1010) and parses the permissions it needs based on the requested access (act 1020). The requested access is then validated using the parsed permissions (act 1030). It should be noted that the software agent 70 can provide the license formatted according to the host DRM prior to act 1000. The host application 70 would then be charged with the task of extracting the permissions from the license (act 1010). However, instead of providing the license formatted according to the host DRM, the software agent 70 can provide the parsed permissions. In this way, the host application 180 would not need to extract the permissions, and acts 1000 and 1010 would not need to be performed.

There are several alternatives that can be used with these embodiments. For example, as noted above, a “subsystem” can perform act 228. The subsystem can be on the host device, on the portable memory device, on another device (e.g., in a network), or distributed among one or more of these devices. For example, the subsystem can be a DRM agent in the software agent that connects to the portable memory device, reads the license from the portable memory device, checks the permissions, and then provides the license to the host application. As another example, the portable memory device can comprise a processor that executes its own DRM agent. In such an embodiment, the software agent can ask the DRM agent running on the portable memory device if the host application is allowed to access the content. The DRM agent would then internally fetch the license, check the permissions, and provide the appropriate license to the software agent. More generally, the request to store content protected by a first DRM system can be issued by a first computing platform (e.g., a host device), and the portable license and/or portable file format can be generated by a second computing platform (e.g., a portable memory device connected to the host device or a server in wired or wireless communication with the host device).

It should be noted that a portable memory device is not necessarily needed to provide content and/or a license to the host device. For example, content and/or a license can be downloaded from a server to the host device, can be wirelessly transmitted to the host device from another host device, or can be “sideloaded” from a PC (e.g., downloaded onto a PC and then moved to the portable memory device). (The phrase “wirelessly transmitted” includes “wirelessly accessed.”) Accordingly, a portable memory device is not necessarily needed to practice these embodiments and should not be read into the claims unless explicitly recited therein. Further, as mentioned above, while the license was shown as being stored on the same memory device as the protected content, it should be understood that the license can be stored in any suitable location and not necessarily on the same memory device as the content.

It should also be noted that some of the acts described herein can be performed in a different order. For example, the act of generating a portable license can be performed before or after the act of generating a portable file format. Accordingly, the acts described in the specification and recited in the claims should not be read as requiring a specific order unless explicitly mentioned. Further, while certain acts were described herein as being performed by the software agent, host application, host, or subsystem, it should be noted that these acts can be performed by different entities named or unnamed herein. For example, an environment can be designed such that some or all of the acts performed in the examples by the software agent are instead performed by the host application. Additionally, the host and/or portable memory devices can have other components that perform some or all of the acts. For example, the host or the portable memory device can have a DRM module that checks permissions and updates the license. Accordingly, performance of the acts described herein can be distributed in any suitable fashion. Further, while these embodiments can be implemented in any suitable environment, it is presently preferred that these embodiments be implemented on a TrustedFlash™ platform by SanDisk Corporation.

In one embodiment, a computer-readable storage media stores computer-readable operational instructions (i.e., computer-readable program code) to perform the acts involved in these embodiments. Examples of computer-readable storage media include, but are not limited to, a solid-state storage device, an optical storage device (e.g., a CD or DVD), and a magnetic storage device (e.g., a hard drive). The phrase “computer-readable storage media” is intended to cover either a single storage medium or a plurality of storage media in one or more devices. Accordingly, “computer-readable storage media” can be located in the host device or the portable memory device or both, for example. In one embodiment, the portable memory device can contain computer-readable storage media that carries the operational instructions (i.e., computer-executable code) to implement the software agent. These instructions can be provided to the host device when the portable memory device is put into communication with the host device. These instructions are then stored in computer-readable storage media of the host device. In this way, the software agent can be placed on a host device in a plug-and-play fashion. In another embodiment, the software agent is pre-loaded onto the host device, so the computer-readable storage media in the host device would carry the operational instructions to implement the software agent when sold to the end user.

In any situation, the operational instructions can be executed by one or more processors in the host device, portable memory device, or some other device (e.g., a computer in the network). Further, as mentioned above, the performance of the acts can be distributed. For example, a processor in the portable memory device can execute some of the operational instructions (stored in the computer-readable storage media in the portable memory device or the host), while the processor in the host device can execute other ones of the operational instructions (stored in the computer-readable storage device in the portable memory device or the host). Additionally, instead of being stored in computer-readable media and executed by a processor(s), some or all of the operational instructions can be implemented in hardware. For simplicity, the term “circuitry” will be used herein to cover a purely hardware implementation, a purely software implementation, and/or an implementation that uses both hardware and software. Accordingly, “circuitry” can take the form of a processor and computer-readable program code that is stored in a computer-readable medium and is executable by the processor. “Circuitry” can also take the form of an application specific integrated circuit (ASIC), a programmable logic controller, an embedded microcontroller, and a single-board computer. Accordingly, the term “circuitry” should not be limited to any particular type of implementation, described herein or otherwise. Further, “circuitry” should not be limited to performing the functions described herein. For example, when circuitry takes the form of a processor executing firmware, it should be understood that the processor can perform functions in addition to the ones described above.

The following patent documents contain embodiments that can be used with the embodiments described herein. Each of these patent documents is being filed on the same date as the present application, is assigned to the assignee of the present invention, and is hereby incorporated by reference: “Methods for Linking Content with License,” U.S. patent application Ser. No. ______ (atty. dkt. no. SAN-017); “Apparatuses for Linking Content with License,” U.S. patent application Ser. No. ______ (atty. dkt. no. SAN-020); “Methods for Accessing Content Based on a Session Ticket,” U.S. patent application Ser. No. ______ (atty. dkt. no. SAN-021); “Apparatuses for Accessing Content Based on a Session Ticket,” U.S. patent application Ser. No. ______ (atty. dkt. no. SAN-022); “Methods for Binding Content to a Separate Memory Device,” U.S. patent application Ser. No. ______ (atty. dkt. no. SAN-018); “Apparatuses for Binding Content to a Separate Memory Device,” U.S. patent application Ser. No. ______ (atty. dkt. no. SAN-023); “Method for Allowing Multiple Users to Access Preview Content,” U.S. patent application Ser. No. ______ (atty. dkt. no. 10519-180); “System for Allowing Multiple Users to Access Preview Content,” U.S. patent application Ser. No. ______ (atty. dkt. no. 10519-191); “Method for Allowing Content Protected by a First DRM System to Be Accessed by a Second DRM System,” U.S. patent application Ser. No. ______(atty. dkt. no. 10519-181); “Method for Connecting to a Network Location Associated with Content,” U.S. patent application Ser. No. ______ (atty. dkt. no. 10519-182); and “System for Connecting to a Network Location Associated with Content,” U.S. patent application Ser. No. ______ (atty. dkt. no. 10519-189).

It is intended that the foregoing detailed description be understood as an illustration of selected forms that the invention can take and not as a definition of the invention. It is only the following claims, including all equivalents, that are intended to define the scope of this invention. Finally, it should be noted that any aspect of any of the preferred embodiments described herein can be used alone or in combination with one another.

What is claimed is:

1. Computer-readable media storing operational instructions for:
(a) receiving, from an application, a request for a license for content protected by a first digital rights management (DRM) system, the first DRM system being different from the application's DRM system;
(b) generating a license supported by the application's DRM system from a license supported by the first DRM system; and
(c) providing the generated license to the application.

2. The computer-readable media of claim 1, wherein the computer-readable media is part of a device comprising the application.

3. The computer-readable media of claim 1, wherein a first device comprises the application, and wherein the computer-readable media is part of a second device in communication with the first device.

4. The computer-readable media of claim 3, wherein the second device comprises a portable memory device.

5. The computer-readable media of claim 1 further storing instructions for recognizing the license supported by the first DRM system.

6. The computer-readable media of claim 1, wherein the content is stored in a file comprising a file format, and wherein the computer-readable media further stores instructions for recognizing the file format.

7. The computer-readable media of claim 1, wherein the generated license comprises at least one permission from the license supported by the first DRM system.

8. The computer-readable media of claim 1, wherein the generated license comprises at least one permission not in the license supported by the first DRM system.

9. The computer-readable media of claim 8, wherein the at least one permission comprises one or both of a move restriction and a copy restriction.

10. Computer-readable media storing operational instructions for:
(a) receiving a request to store content protected by a first digital rights management (DRM) system; and
(b) performing one or both of the following:
(b1) generating a portable license for the content from a license supported by the first DRM system; and
(b2) generating a portable file format for the content from a file format supported by the first DRM system.

11. The computer-readable media of claim 10, wherein the operational instructions for (b) are stored in a device comprising an application providing the request.

12. The computer-readable media of claim 10, wherein a first device comprises an application providing the request, and wherein the operational instructions for (b) are stored in a second device in communication with the first device.

13. The computer-readable media of claim 12, wherein the second device comprises a portable memory device.

14. The computer-readable media of claim 10 further storing operational instructions for storing information associated with the content, wherein the information specifies that, when an attempt is made to access the content, the content should be handled by a component that provides cross-DRM functionality.

15. The computer-readable media of claim 10 further storing operational instructions for performing both (b1) and (b2).

16. A system for storing content protected by a first digital rights management (DRM) system in a portable format, the system comprising:
a first computing platform, in communication with a second computing platform, the first computing platform comprising circuitry operative to:
(a) receive a request from the second computing platform to store content protected by a first DRM system; and
(b) perform one or both of the following:
(b1) generating a portable license for the content from a license supported by the first DRM system; and
(b2) generating a portable file format for the content from a file format supported by the first DRM system.

17. The system of claim 16, wherein the second computing platform comprises a host device, and wherein the first computing platform is part of a portable memory device in communication with the host device.

18. The system of claim 16, wherein the first computing platform comprises a software agent that performs (b).

19. The system of claim 16, wherein the circuitry is further operative to store information associated with the content, wherein the information specifies that, when an attempt is made to access the content, the content should be handled by a component that provides cross-DRM functionality.

20. The system of claim 16, wherein the circuitry is further operative to perform both (b1) and (b2).
